(19) United States
(12) Patent Application Publication
(10) Pub. No.: US 2025/0376407 A1
(43) Pub. Date: Dec. 11, 2025

(54) PRODUCTION METHOD FOR POROUS GLASS PREFORM, PRODUCTION METHOD FOR TRANSPARENT GLASS PREFORM, AND PRODUCTION APPARATUS FOR POROUS GLASS PREFORM

(71) Applicant: Shin-Etsu Chemical Co., Ltd., Tokyo (JP)

(72) Inventors: Naoto NODA, Ibaraki (JP); Keishu UCHIMURA, Tokyo (JP)

(21) Appl. No.: 19/226,025

(22) Filed: Jun. 2, 2025

(30) Foreign Application Priority Data
Jun. 5, 2024 (JP) 2024-091775

(51) Int. Cl. C03B 37/014; G06T 7/50; G06T 7/73

(52) U.S. Cl. CPC C03B 37/01406; C03B 37/01446; G06T 7/50; G06T 7/73; C03B 2207/70; G06T 2207/20081; G06T 2207/30108

(57) ABSTRACT

Provided is a production method for a porous glass preform which forms the porous glass preform by depositing glass fine particles, which are generated by burner flame from a burner, on a tip of a starting material rotating about a vertical axis, and lifting the starting material, the production method including: imaging, with one or more cameras, a deposition surface of the glass fine particles in the starting material and the burner flame, and acquiring image data obtained by projecting an image of the deposition surface and an image of the burner flame on a same coordinate plane; and performing image processing on the image data to calculate a feature quantity of a spatial relationship between the deposition surface and the burner flame.

The contents of the following patent application (s) are incorporated herein by reference: NO. 2024-091775 filed in JP on Jun. 5, 2024.

### BACKGROUND

### 1. Technical Field

The present invention relates to a production method for a porous glass preform, a production method for a transparent glass preform, and a production apparatus for a porous glass preform.

### 2. Related Art

Patent Document 1 describes “the deposition shape of a glass fine particle deposit 14 is monitored while depositing glass fine particles, and at least one of flow rates of glass raw material gases to be charged into a core burner 17 and a cladding burner 18 that are glass fine particle producing burners, flow rates of flame forming gases, or positions of the core burner 17 and the cladding burner 18 relative to the glass fine particle deposit 14 is controlled while controlling a lifting speed of the glass fine particle deposit 14, so that the deposition shape becomes a target shape” (Abstract). Patent Document 2 describes that “extracting image data representing a state of at least the flame or the particle flow from a two-dimensional image obtained by the imaging apparatus . . . specifically, the contour of the flame or the particle flow is clarified after the two-dimensional image from the signal processing unit 104 is adjusted in luminance. In addition, the calculation unit 105 regressively predicts a refractive index profile of the transparent glass preform 140, serving as an objective variable, from the explanatory variable including data obtained by coordinating the contour of at least the flame or the particle flow. More specifically, contour data of the flame or the particle flow, a burner installation position (burner installation position and burner installation angle along the burner X-axis), a flow rate of a glass raw material gas (including a raw material of a refractive index adjusting dopant), a flow rate of a fuel gas (H₂), a flow rate of a combustible assist gas (O2), conditions of dehydration and sintering when the glass fine particle deposit 14 is vitrified into transparent glass (temperature, gas flow rate), and the like are set as explanatory variables, and data characterizing a refractive index profile is set as an objective variable.” (paragraph 0032). Patent Document 3 describes that “detects an edge shape of the deposition surface from the deposition surface image acquired by the imaging apparatus, and quantifies the degree of deformation of the edge shape, to determine whether or not the glass fine particle deposits are good” (Abstract). Patent Document 4 discloses that “measures luminance of a preform and its periphery from at least one direction in an axial direction and/or radial direction of the porous glass preform, and detects, as shape and position of the preform, a measurement position at which a maximum value of a luminance change rate in the axial direction and/or radial direction is obtained” (paragraph 0011).

### PRIOR ART DOCUMENTS

### Patent Documents

Patent Document 1: Japanese Patent Application Publication No. 2012-91965
Patent Document 2: WO 2021/235408
Patent Document 3: WO 2022/186341
Patent Document 4: Japanese Patent Application Publication No. H10-72225

### BRIEF DESCRIPTION OF THE DRAWINGS

FIG. 1 illustrates an example of a production apparatus 11 for a transparent glass preform according to an embodiment.

FIG. 2 is a flowchart illustrating an example of a production method for a transparent glass preform according to an embodiment.

FIG. 3 illustrates an example in which a boundary point between a deposition surface of a porous glass preform 1 and a background and a boundary point between a flame of a core forming burner 40 and the background are extracted by image processing according to an embodiment and plotted on an xy plane.

FIG. 4 illustrates an example of a refractive index distribution of the transparent glass preform according to an embodiment.

FIG. 5 illustrates an example of an in-lot temporal variation of a relative distance d between a tip center position of the deposition surface and a flame center.

FIG. 6 illustrates an example of the in-lot temporal variation of a deposition surface shape fitting coefficient a2.

FIG. 7 is a graph illustrating a correlation between an actual measurement value and a predicted value of an objective variable of training data and test data when training is performed with a model according to an embodiment.

FIG. 8 is a graph illustrating a correlation between an actual measurement value and a predicted value of an objective variable of training data and test data when training is performed with a model according to a comparative example.

### DESCRIPTION OF EXEMPLARY EMBODIMENTS

Hereinafter, the present invention will be described through embodiments of the invention, but the following embodiments do not limit the invention according to the claims. In addition, not all combinations of features described in the embodiments are essential to the solution of the invention.

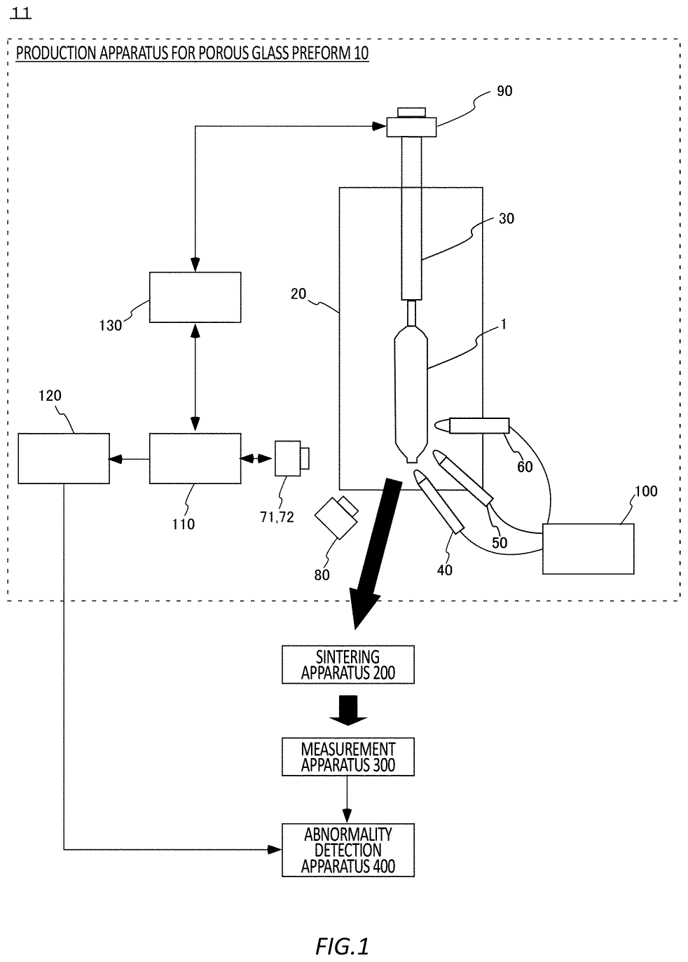

FIG. 1 illustrates an example of a production apparatus 11 for a transparent glass preform according to an embodiment. The production apparatus 11 for the transparent glass preform according to the present embodiment includes a production apparatus 10 for a porous glass preform, a sintering apparatus 200, a measurement apparatus 300, and an abnormality detection apparatus 400. In FIG. 1, a flow direction of a signal is indicated by a thin arrow, and a conveying direction of a porous glass preform 1 and the transparent glass preform is indicated by a thick arrow. In a following description, the production apparatus 11 for the transparent glass preform may be simply referred to as the production apparatus 11, and similarly, the production apparatus 10 for the porous glass preform 1 may be simply referred to as the production apparatus 10.

The production apparatus 10 for the porous glass preform 1 according to the present embodiment includes a chamber 20, a shaft 30, a core forming burner 40, cladding forming burners 50 and 60, CCD cameras 71 and 72, a light source 80, and a lift rotation apparatus 90. The production apparatus 10 according to the present embodiment further includes a mass flow controller (MFC) 100, an image processing apparatus 110, an image analysis apparatus 120, and a control apparatus 130.

The production apparatus 10 for the porous glass preform 1 forms a porous glass preform by depositing glass fine particles, which are generated by burner flame from a burner, on a tip of a starting material rotating about a vertical axis, and lifting the starting material. More specifically, the production apparatus 10 deposits glass fine particles, which are generated by a Vapor-phase Axial Deposition (VAD) method in the chamber 20, on an axial tip of the starting material attached to the shaft 30 which rises while rotating about the vertical axis in a state of being suspended inside the chamber 20 from a position above the chamber 20. The VAD method is a method in which a combustible gas and a combustible assist gas are fed into a burner to generate oxyhydrogen flame, and a raw material gas such as silicon tetrachloride or germanium tetrachloride is introduced into the flame to cause a hydrolysis reaction, thereby producing glass fine particles. The production apparatus 10 forms the porous glass preform 1 by growing a deposit of glass fine particles into a columnar shape at the tip of the starting material.

The core forming burner 40 and the cladding forming burners 50 and 60 are burners used in the VAD method described above, and are arranged on a lower side inside the chamber 20. The core forming burner 40 is a glass fine particle generating burner which generates glass fine particles to be a core of an optical fiber. The core forming burner 40 is supplied with SiCl₄ as a glass raw material gas, GeCl₄ as a dopant gas for increasing a refractive index, H₂ and O₂ as flame forming gases, Ar or N₂ as a seal gas, or the like from a gas supply source. The cladding forming burners 50 and 60 are supplied with SiCl₄ as a glass raw material gas, H₂ and O₂ as flame forming gases, Ar or N₂ and Air, as seal gases, or the like from the gas supply source.

The CCD cameras 71 and 72 are examples of one or more cameras which image a deposition surface of glass fine particles in the starting material and burner flame. The CCD camera 71 is arranged outside the chamber 20, images the deposition surface of glass fine particles in the starting material, and outputs image data to the image processing apparatus 110. The CCD camera 72 is arranged outside the chamber 20, images burner flame ejected from the core forming burner 40, and outputs image data to the image processing apparatus 110. In a following description, the burner flame may be simply referred to as flame. Note that the production apparatus 10 may use one or more CMOS cameras instead of the CCD cameras 71 and 72.

The light source 80 is arranged outside the chamber 20 and irradiates the porous glass preform 1 with light. The light source 80 irradiates the porous glass preform 1 to be imaged by the CCD cameras 71 and 72 with light to facilitate image recognition and image processing in the image processing apparatus 110 or the like. The light source 80 may radiate light, for example, in a wavelength region of 400 to 700 nm in consideration of a relationship with a wavelength sensitivity of the CCD cameras 71 and 72. As the light source 80, for example, a white LED lamp having a largest light energy intensity in a wavelength region of 460 to 470 nm and having an energy intensity peak also in a wavelength region of 550 to 600 nm may be used. As an example, the light source 80 is arranged to irradiate at least a deposition surface opposite to a deposition surface on which the flame of the core forming burner 40 impinges.

The lift rotation apparatus 90 lifts, lowers, and rotates the shaft 30. More specifically, the lift rotation apparatus 90 lifts the shaft 30 while rotating around the vertical axis in a state of being suspended from a position above the chamber 20 to an inside of the chamber 20. The MFC 100 controls flow rates of raw material gases supplied from the gas supply source to the core forming burner 40 and the cladding forming burners 50 and 60.

The image processing apparatus 110 causes the CCD cameras 71 and 72 to perform the above-described imaging, and performs image processing on the image data input from the CCD cameras 71 and 72 by a method described in detail later. The image processing apparatus 110 outputs, to the image analysis apparatus 120, the image data subjected to the image processing. The image analysis apparatus 120 analyzes the image data input from the image processing apparatus 110. The image analysis apparatus 120 may also sequentially perform image processing on image data, which is successively acquired during the deposition of the glass fine particles on the tip of the starting material, by using a programming language such as PYTHON (registered trademark). The image analysis apparatus 120 transmits an analysis result to the abnormality detection apparatus 400 by wired communication or wireless communication.

The control apparatus 130 controls operations of the CCD cameras 71 and 72, the lift rotation apparatus 90, the image processing apparatus 110, and the image analysis apparatus 120. As an example, in production of the porous glass preform 1, the control apparatus 130 adjusts a speed at which the lift rotation apparatus 90 lifts the shaft 30, such that a tip position of the porous glass preform 1 in a vertical direction becomes constant. A known method, for example, a method disclosed in Japanese Patent No. 3199642 may also be used to adjust the lifting speed.

The porous glass preform 1 fabricated by the production apparatus 10 is carried into the sintering apparatus 200, and the sintering apparatus 200 fabricates a transparent glass preform from the porous glass preform 1. More specifically, the sintering apparatus 200 dehydrates the porous glass preform 1 formed by the production apparatus 10 in a heating furnace to vitrify the porous glass preform 1 into transparent glass, thereby forming a transparent glass preform.

The production apparatus 11 for the transparent glass preform may fabricate a glass preform for an optical fiber by adjusting a cladding thickness of the transparent glass preform in the sintering apparatus 200 or in an apparatus outside the sintering apparatus 200. The production apparatus 11 may further fabricate the optical fiber by spinning the glass preform for the optical fiber to a predetermined diameter. The production apparatus 11 may also carry the transparent glass preform into the measurement apparatus 300 before adjusting the cladding thickness of the transparent glass preform.

When the transparent glass preform fabricated by the sintering apparatus 200 is carried in, the measurement apparatus 300 measures a refractive index distribution of the transparent glass preform in a radial direction for a plurality of places along a longitudinal direction of the transparent glass preform by using, for example, a preform analyzer. More specifically, the measurement apparatus 300 may measure the refractive index distribution by causing a laser beam to be incident from a side surface of the transparent glass preform along a cross section perpendicular to an axis of the transparent glass preform to scan across a plane, and measuring a change in a refractive angle of the emitted beam within the plane. The measurement apparatus 300 transmits a measurement result to the abnormality detection apparatus 400 by wired communication or wireless communication.

The abnormality detection apparatus 400 receives the measurement result from the measurement apparatus 300. Based on the refractive index distribution indicated by the measurement result, the abnormality detection apparatus 400 estimates a value of an optical characteristic of the optical fiber to be created from the transparent glass preform for which the refractive index distribution is measured, that is, a target optical fiber. The value of the optical characteristic of the optical fiber may be, for example, at least one of a cutoff wavelength, a mode field diameter, or a zero dispersion wavelength.

The abnormality detection apparatus 400 may estimate the value of the optical characteristic of the optical fiber from the refractive index distribution by using a finite element method. More specifically, the estimated value of the optical characteristic of the optical fiber may be calculated by fitting the refractive index distribution to a dimension of the target optical fiber and solving a Maxwell equation, or the like.

The abnormality detection apparatus 400 may receive the analysis result from the image analysis apparatus 120 of the production apparatus 10 instead of or in addition to receiving the measurement result from the measurement apparatus 300. The abnormality detection apparatus 400 may estimate the value of the optical characteristic of the optical fiber from the analysis result by the image analysis apparatus 120, by using a trained model to be described in detail later.

The abnormality detection apparatus 400 determines whether or not the estimated value deviates from a predetermined target value. When the estimated value deviates from the target value, the abnormality detection apparatus 400 decides to perform predetermined treatment. The target value is, for example, a value which complies with a standard (such as ITU-T G. 652 Recommendations). For example, when the estimated value is included within ±several percent of the target value, the abnormality detection apparatus 400 may determine that the estimated value does not deviate from the target value.

When deciding to perform the predetermined treatment, the abnormality detection apparatus 400 instructs the production apparatus 10 to perform the decided treatment. Alternatively, the abnormality detection apparatus 400 may transmit its decision to perform the treatment, to the control apparatus 130 of the production apparatus 10 by wired communication or wireless communication.

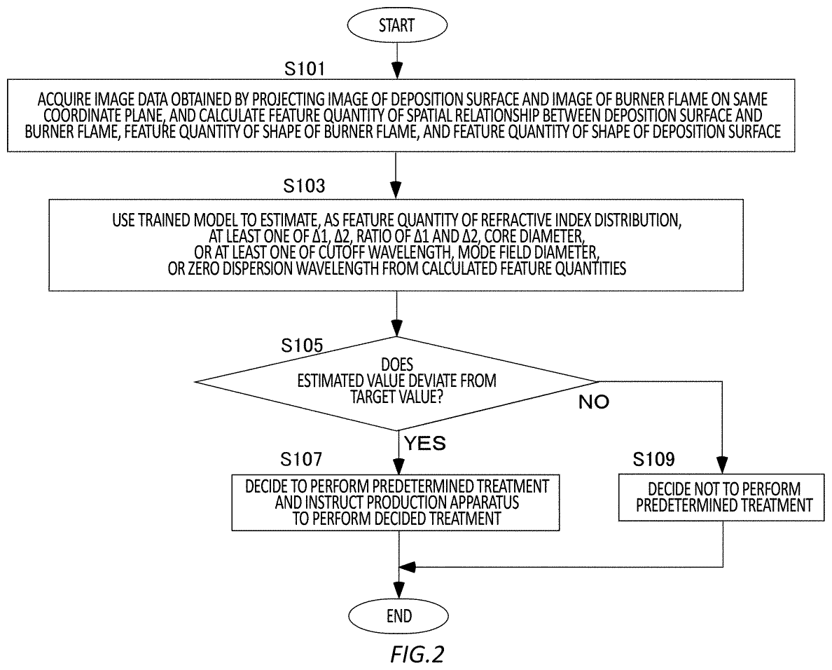

FIG. 2 is a flowchart illustrating an example of a production method for the transparent glass preform according to an embodiment. An example of the production method for the transparent glass preform performed by the production apparatus 11 for the transparent glass preform of the present embodiment schematically described above will be described with reference to the flowchart of FIG. 2.

In the production apparatus 10, the image processing apparatus 110 acquires image data obtained by projecting, on a same coordinate plane, the image of the deposition surface and the image of the burner flame captured by the CCD cameras 71 and 72, and performs image processing on the image data. The image analysis apparatus 120 calculates a feature quantity of a spatial relationship between the deposition surface and the burner flame from the image data subjected to the image processing by the image processing apparatus 110 (step S101).

The feature quantity of the spatial relationship may refer to a feature quantity of a relative arrangement, or may refer to a feature quantity of a relative positional relationship. The feature quantity of the spatial relationship may include, for example, a relationship of six degrees of freedom between the deposition surface and the burner flame, a relative angle, a relative position, or the like. In step S101, the image analysis apparatus 120 of the present embodiment also calculates a feature quantity of a shape of the burner flame and a feature quantity of a shape of the deposition surface from the image data subjected to the image processing by the image processing apparatus 110.

Details of a method of calculating each of the above-described feature quantities from the image data will be described later. Note that a combination of the image processing apparatus 110 and the image analysis apparatus 120 is an example of a feature quantity calculation unit which acquires image data obtained by projecting, on the same coordinate plane, the image of the deposition surface and the image of the burner flame captured by one or more cameras and calculates a feature quantity of the spatial relationship between the deposition surface and the burner flame by performing image processing on the image data.

Here, as described above, the CCD camera 71 images the deposition surface of the glass fine particles in the starting material, and outputs the image as image data via the image processing apparatus 110. The CCD camera 72 images burner flame ejected from the core forming burner 40, and outputs it as image data via the image processing apparatus 110.

The CCD camera 71 may image the deposition surface of glass fine particles in the starting material from an angular direction that is not parallel to a central axis of the starting material, whereby a degree of inclination of an axis of the porous glass preform 1 formed from the starting material can be evaluated. An optical axis of the CCD camera 71 may have an angle of 45 degrees or more and 90 degrees or less, specifically, may have an angle of 60 degrees or more and 90 degrees or less, or more specifically, may have an angle of 80 degrees or more and 90 degrees or less with respect to a central axis of the porous glass preform 1.

Similarly, the CCD camera 72 may image the flame of the core forming burner 40 from an angular direction that is not parallel to a central axis of the core forming burner 40, whereby the shape of the flame ejected from the core forming burner 40 can be evaluated from a lateral direction. The CCD camera 72 may image the flame of the core forming burner 40 from an angular direction that is not parallel to both the central axis of the core forming burner 40 and the central axis of the porous glass preform 1, whereby a position and a direction in which the flame ejected from the core forming burner 40 impinges on the deposition surface of the porous glass preform 1 can be evaluated. An optical axis of the CCD camera 72 may have an angle of 45 degrees or more and 90 degrees or less, specifically, may have an angle of 60 degrees or more and 90 degrees or less, or more specifically, may have an angle of 80 degrees or more and 90 degrees or less with respect to the central axis of the core forming burner 40. Further, the optical axis of the CCD camera 72 may have an angle of 45 degrees or more and 90 degrees or less, may have an angle of 60 degrees or more and 90 degrees or less, or may have an angle of 80 degrees or more and 90 degrees or less with respect to the central axis of the porous glass preform 1.

An angle θ (degrees) formed by the optical axis of the CCD camera 71 and the optical axis of the CCD camera 72 may be 0 degrees or more and 20 degrees or less, or 160 degrees or more and 180 degrees or less, specifically, may be 0 degrees or more and 10 degrees or less, or 170 degrees or more and 180 degrees or less, or more specifically, may be 0 degrees or more and 5 degrees or less, or 175 degrees or more and 180 degrees or less. In this case, the image analysis apparatus 120 which analyzes the image data from the CCD cameras 71 and 72 can easily grasp a relative relationship between the shape of the deposition surface of the porous glass preform 1 and the shape of the flame ejected from the core forming burner 40.

The optical axis of the CCD camera 71 and the optical axis of the CCD camera 72 may be parallel to each other, that is, the angle formed by them may be set to 0 degrees or 180 degrees. Therefore, instead of the CCD camera 71 and the CCD camera 72, one CCD camera using a wide-angle lens may image, on a same screen, the deposition surface of the glass fine particles in the starting material and the flame ejected from the core forming burner 40. In this case, the relative positional relationship between the deposition surface and the flame can be evaluated on the same screen.

Alternatively, the CCD cameras 71 and 72 may also image the deposition surface and the flame from directions directly opposite to each other, respectively, and invert one of the image of the deposition surface or the image of the flame, thereby arranging both the images on the same coordinate plane, that is, acquiring image data projected on the same coordinate plane. In this case, there is an advantage that it becomes easier to achieve both imaging from an illumination position where a contrast between the porous glass preform 1 and a background increases and imaging via a wavelength filter which makes a shape of a flame flow of the flame ejected from the core forming burner 40 easier to see. Note that, when separate cameras are used as described above, for example, the camera for imaging flame may be an infrared camera, and setting of a spectral sensitivity characteristic or the like may be different between both cameras. Note that the production apparatus 10 may image each of the deposition surface and the flame from various angles by using a plurality of cameras. In this case, the production apparatus 10 can increase an amount of information acquired from them, and an accuracy of regression described later can be improved.

The imaging by the CCD camera 71 and the CCD camera 72 may be performed with a synchronized timing, and in this case, when a rotation speed of the shaft 3 is defined as r (revolutions per minute), a time difference t (seconds) between both may be set as:

$$\frac{θ - 20}{6 r} \leq t \leq \frac{θ + 20}{6 r} \qquad ( Expression 1 )$$

$$or$$

$$\frac{θ - 200}{6 r} \leq t \leq \frac{θ - 160}{6 r} . \qquad ( Expression 2 )$$

In this case, a relative positional relationship between a tip portion of the porous glass preform 1 and the flame ejected from the core forming burner 40 can be easily evaluated on the same screen. In addition, for example, the time difference t may also be set as:

$$\frac{θ - 10}{6 r} \leq t \leq \frac{θ + 10}{6 r} \qquad ( Expression 3 )$$

$$or$$

$$\frac{θ - 190}{6 r} \leq t \leq \frac{θ - 170}{6 r} , \qquad ( Expression 4 )$$

and
more specifically, may also be approximated as:

$$t = \frac{θ}{6 r} \qquad ( Expression 5 )$$

$$or$$

$$t = \frac{θ - 180}{6 r} . \qquad ( Expression 6 )$$

In addition, images may be continuously captured with the CCD camera 71 and the CCD camera 72 by video imaging and temporarily stored, and a still image may be extracted from the continuous data at a timing as described above.

As a module of the CCD camera 71 and the CCD camera 72, a black-and-white camera module may be used, or a color camera module may be used. As the spectral sensitivity characteristic of the CCD camera, a peak sensitivity may be 450 to 600 nm, and a sensitivity at 850 nm may be 10% or more of the peak sensitivity. In addition, as a number of effective pixels of the CCD camera increases, high-resolution data can be obtained, but a data capacity increases. In this regard, as the CCD camera 71 and the CCD camera 72, for example, a camera in which the number of effective pixels is 768×494 may be used.

In the production apparatus 10 according to the present embodiment, calculating the feature quantity of the spatial relationship between the deposition surface and the burner flame from the image data obtained by projecting the image of the deposition surface and the image of the burner flame on the same coordinate plane may be, as an example, calculating, as the feature quantity, a horizontal distance between a tip center position of the deposition surface and a center line of the burner flame from the image data.

More specifically, the production apparatus 10 may detect a boundary point between the deposition surface and the background by performing image processing on the image data, and calculate a feature quantity of the tip center position of the deposition surface from coordinate data of the detected boundary point. The feature quantity of the tip center position of the deposition surface is an example of the feature quantity of the shape of the deposition surface. Note that, in addition to or instead of this, the production apparatus 10 may calculate, from the coordinate data, at least one feature quantity of a feature quantity of an inclination of the deposition surface, a feature quantity of an outer diameter shape of the deposition surface, or a feature quantity of a degree of distortion of the deposition surface, and at least one of these feature quantities may be included in the feature quantity of the shape of the deposition surface.

The production apparatus 10 may also detect a boundary point between the burner flame and the background by performing image processing on the image data, calculate, as coordinates of a center position of the burner flame, each of a plurality of measurement positions on an extension line of a central axis of the burner from coordinate data of the detected boundary point, and calculate an approximate straight line which characterizes the center line of the burner flame. The approximate straight line is an example of the feature quantity of the shape of the burner flame. Note that the approximate straight line can also characterize an angle of the burner flame. Note that the feature quantity of the shape of the burner flame may include, for example, a width of the burner flame or the like in addition to the approximate straight line.

The production apparatus 10 may calculate, as the above-described feature quantity of the spatial relationship, the horizontal distance between the tip center position of the deposition surface and the center line of the burner flame by using the feature quantity of the tip center position of the deposition surface and the approximate straight line. In addition to or instead of this, the production apparatus 10 may calculate, as the above-described feature quantity of the spatial relationship, an angle formed by a center line of the deposition surface and the center line of the burner flame by using the feature quantity of the inclination of the deposition surface and the approximate straight line.

When the coordinates of the boundary point between the deposition surface of the porous glass preform 1 and the background are detected from the image data described above, the production apparatus 10 may, as an example, focus on a luminance component of the image and identify a boundary point where there is a large change in luminance between adjacent points. The production apparatus 10 may use, for example, a Canny method. In a case of using the Canny method, the production apparatus 10 may or may not perform processing of converting the image into a grayscale image including gray shades of 256 gradations from 0 (black) to 255 (white). Note that, when the production apparatus 10 uses a black-and-white camera module as the CCD camera 71, an operation of converting into the grayscale image is unnecessary since the grayscale conversion has already been performed. When the production apparatus 10 uses a color camera module as the CCD camera 71, conversion may be performed into a grayscale value of 256 gradations by using a conversion formula y=0.114B+0.587G+0.299R (ITU-R Rec BT. 601 standard). As the grayscale conversion method, there is an averaging method in which an average of values of B, G, and R is used as the grayscale value, a method in which gamma correction is added to the averaging method, a method using a conversion formula of the CIE XYZ standard, a method in which only an R channel is taken out, or the like, and an appropriate grayscale method may be selected according to obtained image data.

As an example of the case of using the Canny method, the production apparatus 10 first sets two large and small thresholds, that is, a large threshold and a small threshold. When a differential value of a pixel value is greater than or equal to the large threshold, the pixel is regarded as a candidate for the above-described boundary point, and when the differential value is less than or equal to the small threshold, the pixel is regarded as not being the above-described boundary point and is excluded. When the differential value of the pixel value is located between these two thresholds, the pixel is distinguished based on an adjacency relationship between a point regarded as a candidate for the boundary point and a point regarded as not a candidate for the boundary point, and if the pixel is adjacent to the point regarded as the candidate for the boundary point, the pixel is regarded as a candidate for the boundary point, and if not, the pixel is regarded as a pixel that is not the boundary point. The candidate for the boundary point is acquired by the above method.

Thereafter, these candidates are compared with a coordinate range in which a boundary point, which is identified in advance, for example, by imaging an object having a shape similar to that of the porous glass preform 1 with the CCD camera 71 or the like, is likely to be displayed, and a candidate within the range is selected as coordinates of the boundary point. Further, a point sequence group of adjacent boundary points is selected, and when a change in luminance of the point sequence exceeds a predetermined value set in advance, the group is deleted. In such a two-step process, only the boundary point between the deposition surface and the background is detected and output as coordinates on an xy plane.

When calculating a feature quantity of the deposition surface from the obtained coordinate data of the boundary point between the deposition surface of the porous glass preform 1 and the background, for example, from coordinate data of a plurality of obtained boundary points

$$( {x}_{0} , {y}_{0} ) , ( {x}_{1} , {y}_{1} ) , ( {x}_{2} , {y}_{2} ) , … , ( {x}_{n} , {y}_{n} ) , \qquad ( Expression 7 )$$

the production apparatus 10 calculates coordinates of center positions of the deposition surface on a plurality of straight lines orthogonal to the central axis of the porous glass preform 1, and calculates the center line of the deposition surface from an average point of the coordinates. At this time, the coordinates at which a lower end of the deposition surface intersects the center line of the deposition surface are defined as the tip center position of the deposition surface

$$( {b}_{0} , {a}_{0} ) . \qquad ( Expression 8 )$$

The production apparatus 10 further calculates a coefficient of a polynomial of degree three or higher that approximates the coordinate data of the plurality of boundary points. A least squares method may be used for the approximation.

$$y = {a}_{0} + {a}_{1} ( x - {b}_{0} ) + {{a}_{2} ( x - {b}_{0} )}^{2} + {{a}_{3} ( x - {b}_{0} )}^{3} + ... \qquad ( Expression 9 )$$

In this way, the production apparatus 10 can calculate the feature quantity of the tip center position of the deposition surface as

$$( {b}_{0} , {a}_{0} ) , \qquad ( Expression 10 )$$

the feature quantity of the inclination of the deposition surface as

$${a}_{1 ,} \qquad ( Expression 11 )$$

the feature quantity of the outer diameter shape of the deposition surface as

$${a}_{2 ,} \qquad ( Expression 12 )$$

the feature quantity of the degree of distortion of the deposition surface as

$${a}_{3 ,} \qquad ( Expression 13 )$$

or the like.

The production apparatus 10 may perform approximation with a polynomial including a higher-order component. Since a value of the coefficient becomes small for the high-order component, scaling may be performed as necessary. As described above, the production apparatus 10 may select an appropriate grayscale method according to the obtained image data and, for example, may be use several different grayscale methods. Specifically, the production apparatus 10 may detect coordinates of boundary points by using several different grayscale methods, respectively, and perform the above-described operation on the boundary points obtained from these different grayscales (scale-1, scale-2, . . . etc.) to calculate the feature quantity of the deposition surface, thereby, for example, acquiring separate feature quantities such as a1(scale-1), a1(scale-2), and so on for a1. As described above, the different feature quantities acquired using several different grayscale methods may be used to train a learning model to be described in detail later.

As described above, the production apparatus 10 may quantify a difference in a complicated deposition surface shape as several feature quantities, and for example, acquire and calculate these feature quantities during the production, for example, at a constant time interval, and store the feature quantities as data. The production apparatus 10 may also acquire and calculate a feature quantity for each production lot and store the feature quantity as data. When using a plurality of VAD production apparatuses, the production apparatus 10 may acquire and calculate a feature quantity for each production apparatus and store the feature quantity as data. In this case, there is an advantage that it is possible to compare the stored data of the feature quantity of the production of the porous glass preform 1 with data of the refractive index distribution of the transparent glass preform obtained thereafter. In addition, similarly, the production apparatus 10 may acquire and calculate the feature quantity of the burner flame, for example, at a constant time interval and store the feature quantity as data. The production apparatus 10 may use the feature quantity of the shape of the deposition surface and a temporal change of the feature quantity of the shape of the burner flame, for example, a change rate of each shape, a fluctuation of the flame, or the like as a new feature quantity for calculating the above-described feature quantity of the spatial relationship.

When detecting the boundary point between the flame and the background from the above-described image data and calculating the feature quantity of the flame from the coordinate data of the detected boundary point, as an example, the production apparatus 10 sets, on the image, a plurality of measurement positions along the extension line of the burner central axis toward the deposition surface of the porous glass preform 1 from the tip of the core forming burner 40 from which the flame is ejected. The production apparatus 10 sets a straight line in a direction crossing the extension line of the burner central axis at each measurement position, and calculates a luminance distribution on the straight line of the image data.

As an example of the case of calculating the luminance distribution, the production apparatus 10 may first set a region in which flame is reflected, and, within the region, perform conversion into a 256-gradation grayscale value by using the conversion formula y=0.114B+0.587G+0.299R (ITU-R Rec BT. 601 standard). As the grayscale conversion method, there is an averaging method in which an average of values of B, G, and R is used as the grayscale value, a method in which gamma correction is added to the averaging method, a method using a conversion formula of the CIE XYZ standard, a method in which only an R channel is taken out, or the like, and an appropriate grayscale method may be selected according to obtained image data.

The production apparatus 10 performs a first-order differentiation of the luminance distribution calculated on each straight line to calculate a luminance distribution derivative. The production apparatus 10 defines, as the boundary points between the flame and the background, a maximum value and a minimum value of the luminance distribution derivative at this time. Regarding the flame, unlike the image of the deposition surface, there may also be an image in which a contour of the flame is blurred, an image in which bright streaks caused by reaction of the raw material are included within the flame, or the like, and when the maximum value and the minimum value of the derivative are taken, the boundary point between the flame and the background may not be accurately captured. In this case, the production apparatus 10 may calculate a cross-sectional area of the luminance distribution on each straight line, decide a threshold according to a ratio (for example, 0.001) of the cross-sectional area, and define, as the boundary point between the flame and the background, an end of a region where the luminance exceeds the threshold. In this case, when the characteristic of the luminance distribution is different between a right end and a left end of the flame, the definition of the boundary point between the flame and the background may be different between the right end and the left end.

The production apparatus 10 further uses the boundary point data between the flame and the background obtained for each of the plurality of measurement positions on the extension line of the central axis of the core forming burner 40 to identify each coordinates of the center position of the flame, arranges the coordinates on a same coordinate plane as in the previous evaluation of the deposition surface, and calculates a following approximate straight line that characterizes the center of the flame and the angle of the flame, that is, the center line of the flame.

$$y = k x + m \qquad ( Expression 14 )$$

The angle of the flame is represented by k, and these are taken as the feature quantities of the flame.

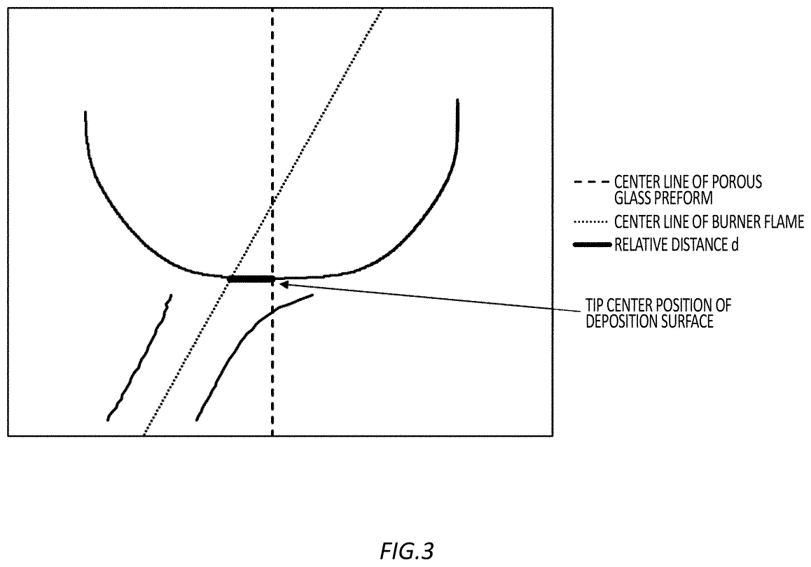

FIG. 3 illustrates an example in which the boundary point between the deposition surface of the porous glass preform 1 and the background and the boundary point between the flame of the core forming burner 40 and the background are extracted by image processing according to an embodiment and plotted on an xy plane. The xy plane illustrated in FIG. 3 is an example of the above-described same coordinate plane on which the image of the deposition surface and the image of the burner flame are projected.

Since the coordinates at which the center line of the flame obtained above intersects with a tip height of the deposition surface

$$( y = {a}_{0} ) \qquad ( Expression 15 )$$

are defined as

$$( \frac{{a}_{0} - m}{k} , {a}_{0} ) , \qquad ( Expression 16 )$$

a relative distance d in a horizontal direction between the tip center position of the deposition surface and the center line of the flame is calculated by a following expression.

$$d = {b}_{0} - \frac{{a}_{0} - m}{k} \qquad ( Expression 17 )$$

This is the feature quantity of the relative position between the deposition surface and the flame. By calculating the relative position between the deposition surface and the flame, the production apparatus 10 can perform comparison even when the deposition center position and the flame center position change between production lots or between production apparatuses.

When comparing a measurement value of the refractive index distribution of the transparent glass preform with the feature quantity obtained from the image during the deposition, the production apparatus 11 may image the deposition surface of the porous glass preform 1 at an interval corresponding to 2000 times or less, specifically 200 times or less, or more specifically 20 times or less a spatial resolution of the preform analyzer which measures the refractive index distribution of the transparent glass preform. That is, when the preform analyzer having a spatial resolution of 0.05 mm is used, the deposition surface of the porous glass preform 1 may be imaged at an interval of 50 mm or less, specifically 5 mm or less, or more specifically 1 mm or less from the porous glass preform 1.

When the porous glass preform 1 fabricated by the VAD method is sintered and vitrified into transparent glass, an axial length shrinks to about half, and thus, when a rising speed of the shaft 30 during the deposition is defined as v (mm/min), the porous glass preform 1 on which the glass fine particles are deposited for 1 minute approximately corresponds to v/2 (mm) of the transparent glass preform after sintering. Therefore, for example, if the rising speed is 1 mm/min, when the deposition surface is imaged at time intervals of one image every two minutes, the result can be compared with that obtained by measuring the refractive index distribution of the transparent glass preform at a pitch of 1 mm.

The result of the image data and the measurement result of the refractive index distribution at a minimum measurement pitch of the preform analyzer substantially match. Regarding the interval of imaging the deposition surface, the deposition surface may be imaged at intervals of one image every one minute, one image every 30 seconds, one image every 10 seconds, and one image every one second. As the imaging interval is shortened, it is also possible to check instantaneous changes during the deposition, such as flame disturbance and changes in the deposition surface shape. On the other hand, when the imaging interval is excessively shortened, enormous image data is processed, and thus image processing takes time.

The above-described image processing of the image data may be sequentially performed during the deposition of the glass fine particles, and further, a production database storing production data including the feature quantity obtained from the image processing may be constructed. In addition, further, a characteristic database of the transparent glass preform storing the feature quantity of the refractive index distribution in the longitudinal direction of the transparent glass preform may be constructed. The learning model may be created by aligning and merging longitudinal positional relationships of the data of both databases or calculating and merging average values.

In the production apparatus 11, for example, the abnormality detection apparatus 400 may calculate the feature quantity of the refractive index distribution from the refractive index distribution of the transparent glass preform measured by the measurement apparatus 300. Here, a relative refractive index difference Δ(r) at a position of a radius r in a core layer of the optical fiber is represented by Δ(r)=100×(n(r)−n)/n(r) with a refractive index n of a cladding layer of the optical fiber as a reference, a relative refractive index difference of a core center portion (r=0) is defined as Δ1, and a local maximum of a relative refractive index difference in a vicinity of an interface between the core layer and the cladding layer of the optical fiber is defined as Δ2. When defined in this manner, the feature quantity of the refractive index distribution calculated from the measured refractive index distribution of the transparent glass preform may be, for example, at least one of Δ1, Δ2, and a ratio of Δ1 and Δ2 calculated based on the refractive index distribution measured for the transparent glass preform, a core diameter, or the estimated value of the optical characteristic of the optical fiber estimated from the refractive index distribution measured for the transparent glass preform. The estimated value of the optical characteristic of the optical fiber may be at least one of a cutoff wavelength, a mode field diameter, and a zero dispersion wavelength.

The abnormality detection apparatus 400 may construct a database of the feature quantity of the spatial relationship and the feature quantity of the refractive index distribution described above. Further, the abnormality detection apparatus 400 may construct a trained model by using the data accumulated in the database to include, as explanatory variables, the feature quantity of the shape of the deposition surface, the feature quantity of the shape of the burner flame, and the feature quantity of the spatial relationship and to include, as an objective variable, the feature quantity of the refractive index distribution, and by training a learning model using these explanatory variables and objective variable. The trained model may be constructed by an external apparatus of the abnormality detection apparatus 400, and the abnormality detection apparatus 400 may acquire the trained model from the external apparatus. The above-described database may also be constructed by an external apparatus of the abnormality detection apparatus 400, and the abnormality detection apparatus 400 may acquire the database from the external apparatus.

Following step S101 of FIG. 2, the abnormality detection apparatus 400 uses the trained model to estimate, as the feature quantity of the refractive index distribution, a value of at least one of Δ1, Δ2, the ratio of Δ1 and Δ2, the core diameter, or at least one of the cutoff wavelength, the mode field diameter, or the zero dispersion wavelength, from the feature quantity of the shape of the deposition surface, the feature quantity of the shape of the burner flame, and the feature quantity of the spatial relationship calculated from the image data during the production of the porous glass preform 1 (step S103).

The abnormality detection apparatus 400 determines whether or not the estimated value deviates from a predetermined target value (step S105). If the estimated value deviates from the target value (step S105: YES), the abnormality detection apparatus 400 decides to perform predetermined treatment, instructs the production apparatus 10 to perform the decided treatment (step S107), and ends the flow. In step S105, if the estimated value does not deviate from the target value (step S105: NO), the abnormality detection apparatus 400 decides not to perform the treatment (step S109), and ends the flow.

The predetermined treatment described above may be, for example, at least one of stopping the production of the porous glass preform 1 by the production apparatus 10, extending a production time of the porous glass preform 1 in the production apparatus 10, adjusting a condition of the gas used during the production of the porous glass preform 1 in the production apparatus 10, adjusting a position of any burner in the production apparatus 10, or performing maintenance on any burner in the production apparatus 10. Note that the burner maintenance may refer to at least one of burner cleaning, burner replacement, burner cover cleaning, or burner cover replacement.

When a predetermined condition is satisfied, for the porous glass preform 1 fabricated by the production apparatus 10, the production apparatus 11 for the transparent glass preform according to the present embodiment estimates a value of an optical characteristic of a target optical fiber, and decides necessity of the above-described treatment based on the estimated value.

For example, the production apparatus 11 may analyze the image data by the image analysis apparatus 120 when a predetermined time has elapsed from start of depositing the glass fine particles on the tip of the starting material in the production apparatus 10 or every time a predetermined time has elapsed, and decide the necessity based on an analysis result. In this case, at a time point of deciding the necessity, the fabrication of the porous glass preform 1 has not been completed yet, and the measurement of the refractive index distribution by the measurement apparatus 300 has not been performed. In this case, the production apparatus 11 can decide to perform the above-described treatment while the glass fine particles are deposited on the starting material in the production apparatus 10, that is, can detect an abnormality at an early stage and immediately feed back to production conditions, and can stabilize the optical characteristic of the target optical fiber fabricated from the starting material.

For example, the production apparatus 11 may decide the necessity every time the porous glass preform 1 is fabricated by the production apparatus 10. For example, the production apparatus 11 may decide the necessity every time a predetermined number of porous glass preforms 1 are created by the production apparatus 10. For example, the production apparatus 11 may decide the necessity every time an operation time of the production apparatus 10 meets a predetermined time. For example, the production apparatus 11 may decide the necessity when any one or both of a condition that a predetermined number of porous glass preforms 1 are created by the production apparatus 10 and a condition that the operation time of the production apparatus 10 meets the predetermined time is satisfied. In these cases, the production apparatus 11 can decide to perform the above-described treatment before the next or subsequent porous glass preform 1 is fabricated in the production apparatus 10, that is, can immediately feed back to the production conditions, and can stabilize the optical characteristic of the target optical fiber fabricated from the next or subsequent porous glass preform 1.

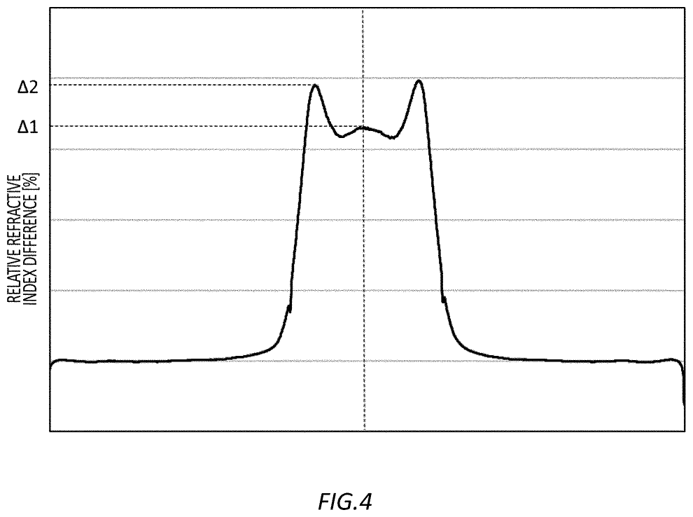

FIG. 4 illustrates an example of the refractive index distribution of the transparent glass preform according to an embodiment. The refractive index distribution of the transparent glass preform consists of the relative refractive index difference of the core layer doped with germanium or the like and having a high refractive index and the relative refractive index difference of the cladding layer, and as described above, the relative refractive index difference Δ(r) at the position of the radius r is represented by Δ(r)=100×(n(r)−n)/n(r) with the refractive index n of the cladding layer as a reference. A vertical axis in FIG. 4 indicates the relative refractive index difference (%).

The relative refractive index difference of the core center portion (r=0) is defined as Δ1, and the local maximum of the relative refractive index difference in the vicinity of the interface between the core layer and the cladding layer is defined as Δ2. In this case, as described above, in addition to Δ1, Δ2, the ratio of Δ1 and Δ2 (that is, Δ2/Δ1), the core diameter, or the like illustrated in FIG. 4, the estimated value of the optical characteristic of the optical fiber such as the cutoff wavelength, the mode field diameter, and the zero dispersion wavelength calculated by applying the dimension of the optical fiber and performing theoretical calculation may also be treated as the feature quantity of the refractive index distribution obtained from the measurement result of the refractive index distribution.

The above-described learning model may be trained by using the variables to construct a trained model. As the algorithm of the learning model, multiple regression, Lasso regression, Ridge regression, Support Vector regression, Random Forest regression, or the like can be used, and an algorithm with a highest accuracy based on the analysis result may be used. In addition, as the algorithm of the learning model, a combination of these methods can be used, and for example, the Random Forest regression may be used after the feature quantity is selected by the Lasso regression, an average of results of a plurality of regressions as exemplified herein may be taken, or a majority decision of a plurality of regressions may be taken.

The production apparatus 11 may prepare the trained model created in this manner and directly estimate the feature quantity or the optical characteristic of the refractive index distribution from the image data during the production by using the trained model. That is, in the production apparatus 11, the image analysis apparatus 120 and the measurement apparatus 300 may be omitted, and the step of calculating the feature quantity or the like of the spatial relationship may be omitted.

In this case, for example, the image processing apparatus 110 images, with one or more cameras, the deposition surface of the glass fine particles in the starting material and the burner flame, and acquires image data obtained by projecting the image of the deposition surface and the image of the burner flame on the same coordinate plane. The abnormality detection apparatus 400 inputs the newly acquired image data to the trained model, which has learned a relationship between the image data during the production of the porous glass preform 1, acquired by the image processing apparatus 110, and the value of the optical characteristic of the optical fiber, thereby causing the trained model to estimate the value of the optical characteristic of the transparent glass preform. Here, the value of the optical characteristic of the optical fiber may be a value calculated from the measurement values of the refractive index distribution in the radial direction measured for a plurality of places along a longitudinal direction of the optical fiber. The value of the optical characteristic of the optical fiber may be, for example, at least one of Δ1, Δ2, the ratio of Δ1 and Δ2, the core diameter, the cutoff wavelength, the mode field diameter, or the zero dispersion wavelength.

As an example of the production method for the transparent glass preform according to the present embodiment, in the deposition of the VAD method, SiCl₄ and GeCl₄ as glass raw materials were supplied to the core forming burner 40, and SiCl₄ as a glass raw material was supplied to the cladding forming burners 50 and 60. A speed at which the lift rotation apparatus 90 lifts the shaft 30 was adjusted such that the tip position of the porous glass preform 1 in the vertical direction was constant.

The tip portion of the porous glass preform 1 was imaged with the CCD camera 71, and the image analysis apparatus 120 which analyzes image data output by the image processing apparatus 110 was used to sequentially quantify, during the deposition, the coordinate data of the boundary point between the deposition surface of the porous glass preform 1 and the background, the tip center position of the deposition surface, coefficients a1 to a6 obtained by fitting the deposition surface with a six-order function, the coordinate data of the boundary point between the flame of the core forming burner 40 and the background, the flame center position, the relative distance d (unit: pixel) between the tip center position of the deposition surface and the flame center, or the like.

The porous glass preform 1 deposited by the VAD method was then heated in an electric furnace of the sintering apparatus 200 to be dehydrated and vitrified into transparent glass, thereby forming a transparent glass preform. In the measurement apparatus 300, the refractive index distribution in the longitudinal direction of the transparent glass preform was measured, and the optical characteristic such as the cutoff wavelength, the mode field diameter, and the zero dispersion wavelength were calculated and estimated.

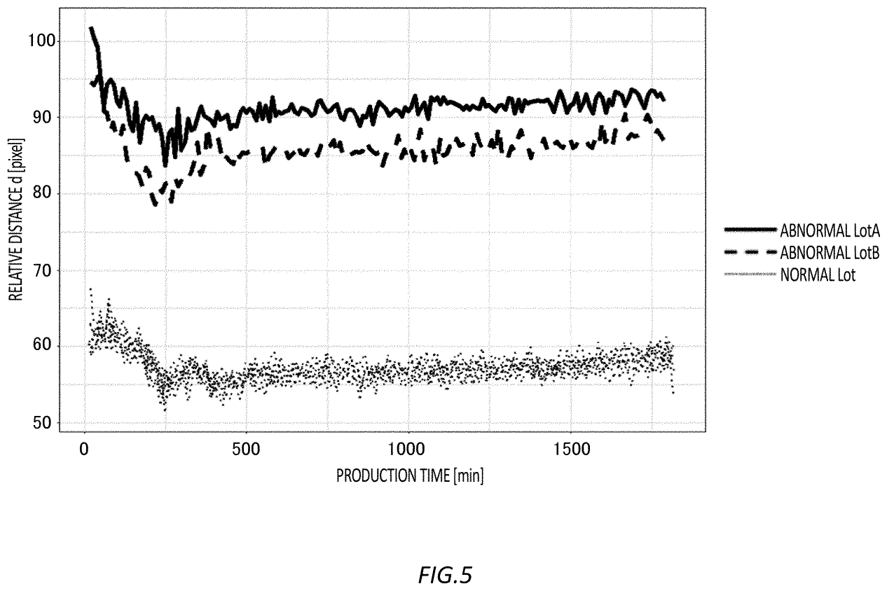

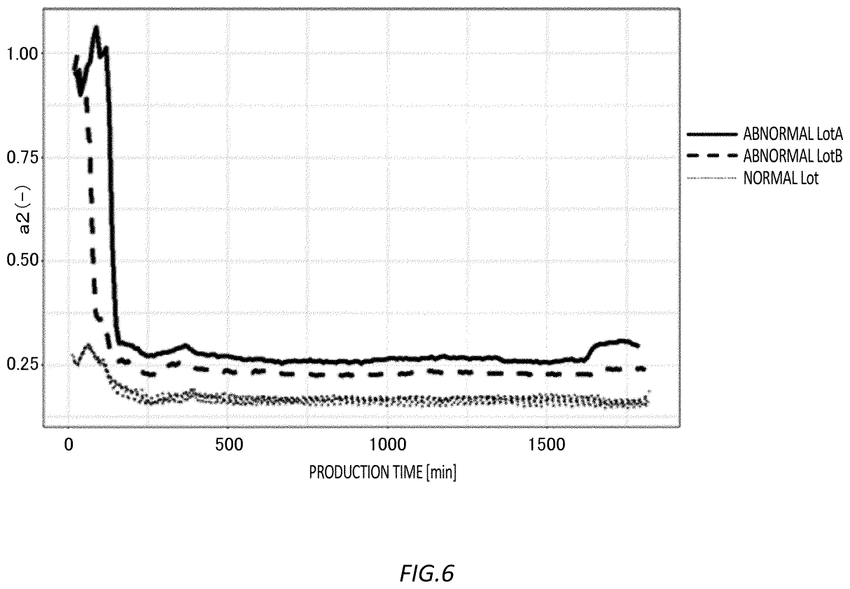

FIG. 5 illustrates an example of an in-lot temporal variation of the relative distance d between the tip center position of the deposition surface and the flame center. In FIG. 5, a horizontal axis indicates the production time (min), and a vertical axis indicates the relative distance d (pixel). FIG. 6 illustrates an example of the in-lot temporal variation of a deposition surface shape fitting coefficient a2. In FIG. 6, a horizontal axis indicates the production time (min), and a vertical axis indicates the deposition surface shape fitting coefficient a2. In FIGS. 5 and 6, a graph of an abnormal LotA is indicated by a thick solid line, a graph of an abnormal LotB is indicated by a thick coarse broken line, and a graph of a normal Lot (average) is indicated by a thin fine broken line. Table 1 below shows core estimated values (longitudinal average values) and Δ1, Δ2, and Δ2/Δ1 of the zero dispersion wavelengths of the abnormal LotA, the abnormal LotB, and the normal Lot (average).

TABLE 1

| | ABNORMAL LotA | ABNORMAL LotB | NORMAL Lot (AVERAGE) |
|---|---|---|---|
| ZERO DISPERSION WAVELENGTH | 1312.5 nm | 1310.7 nm | 1308.1 nm |
| (VALUE CALCULATED FROM | | | |
| MEASURED VALUE OF | | | |
| REFRACTIVE INDEX | | | |
| DISTRIBUTION) | | | |
| Δ1 | 0.390% | 0.400% | 0.347% |
| Δ2 | 0.323% | 0.352% | 0.387% |
| Δ2/Δ1 | 0.828 | 0.880 | 1.11 |

As shown in Table 1, while the zero dispersion wavelength of the normal Lot was 1308.1 nm, the zero dispersion wavelength of the abnormal LotA was as large as 1312.5 nm, and the zero dispersion wavelength of the abnormal LotB was as large as 1310.7 nm. In addition, also regarding Δ1, Δ2, and Δ2/Δ1, differences were observed among the abnormal LotA, the abnormal LotB, and the normal Lot, and it was found that the refractive index distribution shape was changed. In the abnormal LotA and the abnormal LotB, the relative distance d between the tip center position of the deposition surface and the flame center was large as illustrated in FIG. 5, and the deposition surface shape fitting coefficient a2 was large as illustrated in FIG. 6, as compared with the other normal Lot (target Lot). In particular, regarding an initial stage of the deposition, in the abnormal LotA and the abnormal LotB, a2 is considerably large. That is, this indicates that, as compared with the normal Lot, in the abnormal LotA and the abnormal LotB, the flame center of the core forming burner 40 and the center of the porous glass preform 1 were shifted further apart, the tip shape of the porous glass preform 1 is deposited in a steeper shape, and a2 is increased.

It is indicated that as a result of the porous glass preform 1 changing to a steep shape, the refractive index distribution changes and the zero dispersion wavelength increases. As one of causes of increase in the relative distance d between the tip center position of the deposition surface and the flame center, degradation of a burner cover tip over time is considered. At the burner cover tip, GeO₂ and SiO₂ derived from the raw material may adhere and solidify to form glass beads, and when the glass beads are formed, a state of flame changes near the burner cover tip, so that a direction of flame changes, and as a result, it is considered that a flame-soot relative distance changes. In such a case, replacement of the burner cover, cleaning of the burner cover, and position adjustment of the flame by burner position adjustment are performed, so that it is possible to approach the normal Lot and normalize the zero dispersion wavelength. As described above, according to the production apparatus 11, for example, by quantifying the deposition surface shape and the flame shape/position during the deposition of the glass fine particles and performing analysis in real time, it is possible to detect the abnormal LotA, the abnormal LotB, or the like at an early stage and to perform treatment at an early stage, and it is possible to stabilize the characteristic within a lot and between lots.

By using the production database storing the production data including the feature quantities obtained from the image processing and the characteristic database of the transparent glass preform, a learning model was created by a random forest in which the feature quantity of the tip center position of the deposition surface, the feature quantity of the inclination of the deposition surface, the feature quantity of the outer diameter shape of the deposition surface, the feature quantity of the degree of distortion of the deposition surface, a feature quantity of the center line of the flame, a feature quantity of the angle of the flame, and a feature quantity of the relative distance in the horizontal direction between the tip center of the porous glass preform and the center of the burner flame are included as explanatory variables, and a ratio of the relative refractive index differences Δ1 and Δ2 is included as an objective variable.

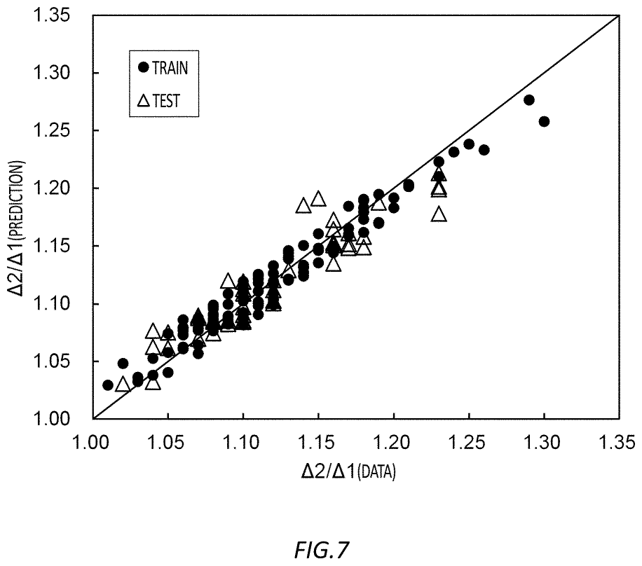

FIG. 7 is a graph illustrating a correlation between an actual measurement value and a predicted value of the objective variable of training data and test data when training is performed with the model according to an embodiment. In FIG. 7, a horizontal axis indicates the actual measurement value of the objective variable Δ2/Δ1, and a vertical axis indicates the predicted value of the objective variable Δ2/Δ1. In FIG. 7, the training data is plotted by circles, and the test data is plotted by triangles. A proportion of the training data to the test data was 75:25. As illustrated in FIG. 7, a significant correlation was found between the actual measurement value and the predicted value of the objective variable. By creating such a predictive learning model, the production apparatus 11 can predict the feature quantity of the refractive index distribution and the estimated value of the optical characteristic from the result obtained from the image processing.

Next, as a comparative example with the present embodiment, a learning model is created by a random forest in which the feature quantity of the tip center position of the deposition surface, the feature quantity of the inclination of the deposition surface, the feature quantity of the outer diameter shape of the deposition surface, and the feature quantity of the degree of distortion of the deposition surface are included in explanatory variables, and the ratio of the relative refractive index differences Δ1 and Δ2 is included in an objective variable.

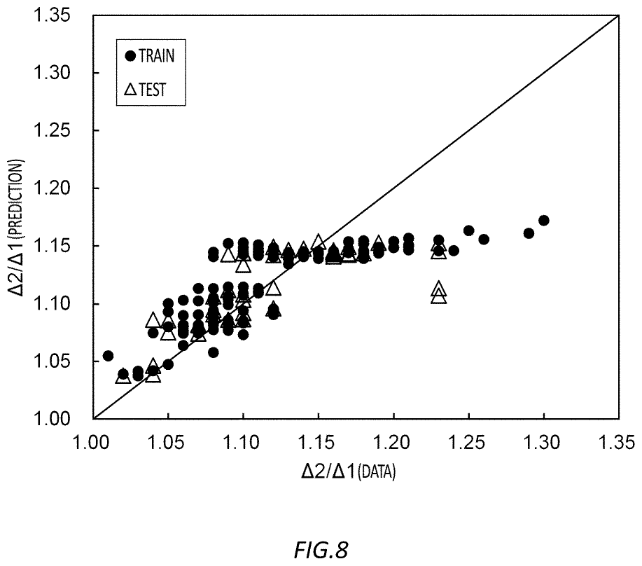

FIG. 8 is a graph illustrating a correlation between an actual measurement value and a predicted value of the objective variable of training data and test data when training is performed with the model according to the comparative example. In FIG. 8, a horizontal axis indicates the actual measurement value of the objective variable Δ2/Δ1, and a vertical axis indicates the predicted value of the objective variable Δ2/Δ1. In FIG. 8, the training data is plotted by circles, and the test data is plotted by triangles. As illustrated in FIG. 8, no significant correlation was found between the actual measurement value and the predicted value of the objective variable. Therefore, it was found that a model with a higher accuracy can be obtained by including, as explanatory variables, the feature quantity of the shape of the burner flame and the feature quantity of the spatial relationship between the deposition surface and the burner flame in addition to the feature quantity of the shape of the deposition surface.

While the present invention has been described by way of the embodiments, the technical scope of the present invention is not limited to the above-described embodiments. It is apparent to persons skilled in the art that various alterations or improvements can be made to the above-described embodiments. It is also apparent from description of the claims that the embodiments to which such modifications or improvements are made may be included in the technical scope of the present invention.

It should be noted that each process of the operations, procedures, steps, steps, and the like performed by the apparatus, system, program, and method shown in the claims, specification, or drawings can be executed in any order as long as the order is not indicated by “prior to”, “before”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

1: porous glass preform;
10: production apparatus;
20: chamber;
30: shaft;
40: core forming burner;
50, 60: cladding forming burner;
71, 72: CCD camera;
80: light source;
90: lift rotation apparatus;
100: MFC;
110: image processing apparatus;
120: image analysis apparatus;
130: control apparatus;
200: sintering apparatus;
300: measurement apparatus; and
400: abnormality detection apparatus.

What is claimed is:

1. A production method for a porous glass preform which forms the porous glass preform by depositing glass fine particles, which are generated by burner flame from a burner, on a tip of a starting material rotating about a vertical axis, and lifting the starting material, the production method comprising:
imaging, with one or more cameras, a deposition surface of the glass fine particles in the starting material and the burner flame, and acquiring image data obtained by projecting an image of the deposition surface and an image of the burner flame on a same coordinate plane; and
performing image processing on the image data to calculate a feature quantity of a spatial relationship between the deposition surface and the burner flame.

2. The production method for the porous glass preform according to claim 1, further comprising performing image processing on the image data to calculate a feature quantity of a shape of the burner flame and a feature quantity of a shape of the deposition surface.

3. The production method for the porous glass preform according to claim 1, wherein among the one or more cameras, an optical axis of a camera which images the deposition surface has an angle of 45 degrees or more and 90 degrees or less, specifically, an angle of 60 degrees or more and 90 degrees or less, or more specifically, an angle of 80 degrees or more and 90 degrees or less with respect to a central axis of the porous glass preform, and an optical axis of a camera which images the burner flame has an angle of 45 degrees or more and 90 degrees or less, specifically, an angle of 60 degrees or more and 90 degrees or less, or more specifically, an angle of 80 degrees or more and 90 degrees or less with respect to a central axis of the burner.

4. The production method for the porous glass preform according to claim 2, wherein among the one or more cameras, an optical axis of a camera which images the deposition surface has an angle of 45 degrees or more and 90 degrees or less, specifically, an angle of 60 degrees or more and 90 degrees or less, or more specifically, an angle of 80 degrees or more and 90 degrees or less with respect to a central axis of the porous glass preform, and an optical axis of a camera which images the burner flame has an angle of 45 degrees or more and 90 degrees or less, specifically, an angle of 60 degrees or more and 90 degrees or less, or more specifically, an angle of 80 degrees or more and 90 degrees or less with respect to a central axis of the burner.

5. The production method for the porous glass preform according to claim 1, wherein among the one or more cameras, an angle formed by an optical axis of a camera which images the deposition surface and an optical axis of a camera which images the burner flame is 0 degrees or more and 20 degrees or less or 160 degrees or more and 180 degrees or less, specifically, 0 degrees or more and 10 degrees or less or 170 degrees or more and 180 degrees or less, or more specifically, 0 degrees or more and 5 degrees or less or 175 degrees or more and 180 degrees or less.

6. The production method for the porous glass preform according to claim 2, wherein among the one or more cameras, an angle formed by an optical axis of a camera which images the deposition surface and an optical axis of a camera which images the burner flame is 0 degrees or more and 20 degrees or less or 160 degrees or more and 180 degrees or less, specifically, 0 degrees or more and 10 degrees or less or 170 degrees or more and 180 degrees or less, or more specifically, 0 degrees or more and 5 degrees or less or 175 degrees or more and 180 degrees or less.

7. The production method for the porous glass preform according to claim 1, wherein
the acquiring the image data includes acquiring the image data by imaging the deposition surface and the burner flame with one camera and imaging the deposition surface and the burner flame on a same screen.

8. The production method for the porous glass preform according to claim 1, wherein
the acquiring the image data includes acquiring the image data projected on a same coordinate plane by imaging the deposition surface and the burner flame with two cameras which perform imaging from directions directly opposite to each other, and inverting one of an image of the deposition surface or an image of the burner flame.

9. The production method for the porous glass preform according to claim 2, wherein the calculating the feature quantity of the shape of the deposition surface includes detecting a boundary point between the deposition surface and a background by performing image processing on the image data, calculating, from coordinate data of the boundary point detected, at least one feature quantity of a feature quantity of a tip center position of the deposition surface, a feature quantity of an inclination of the deposition surface, a feature quantity of an outer diameter shape of the deposition surface, or a feature quantity of a degree of distortion of the deposition surface, and including the at least one feature quantity in the feature quantity of the shape of the deposition surface.

10. The production method for the porous glass preform according to claim 2, wherein the calculating the feature quantity of the shape of the burner flame includes detecting a boundary point between the burner flame and a background by performing image processing on the image data, calculating, as coordinates of a center position of the burner flame, each of a plurality of measurement positions on an extension line of a central axis of the burner from coordinate data of the boundary point detected, thereby calculating an approximate straight line which characterizes a center line of the burner flame and an angle of the burner flame, and including the approximate straight line in the feature quantity of the shape of the burner flame.

11. The production method for the porous glass preform according to claim 2, further comprising:
detecting a boundary point between the deposition surface and a background by performing image processing on the image data, and calculating, as the feature quantity of the shape of the deposition surface, a feature quantity of a tip center position of the deposition surface from coordinate data of the boundary point detected;
detecting a boundary point between the burner flame and the background by performing image processing on the image data, calculating, as coordinates of a center position of the burner flame, each of a plurality of measurement positions on an extension line of a central axis of the burner from coordinate data of the boundary point detected, and calculating, as the feature quantity of the shape of the burner flame, an approximate straight line which characterizes a center line of the burner flame; and
calculating, as the feature quantity of the spatial relationship, a horizontal distance between the tip center position of the deposition surface and the center line of the burner flame by using the feature quantity of the tip center position of the deposition surface and the approximate straight line.

12. The production method for the porous glass preform according to claim 2, further comprising:
detecting a boundary point between the deposition surface and a background by performing image processing on the image data, and calculating, as the feature quantity of the shape of the deposition surface, a feature quantity of an inclination of the deposition surface from coordinate data of the boundary point detected;
detecting a boundary point between the burner flame and the background by performing image processing on the image data, calculating, as coordinates of a center position of the burner flame, each of a plurality of measurement positions on an extension line of a central axis of the burner from coordinate data of the boundary point detected, and calculating, as the feature quantity of the shape of the burner flame, an approximate straight line which characterizes an angle of the burner flame; and
calculating, as the feature quantity of the spatial relationship, an angle formed by a center line of the deposition surface and a center line of the burner flame by using the feature quantity of the inclination of the deposition surface and the approximate straight line.

13. A production method for a transparent glass preform, comprising:
fabricating a transparent glass preform by dehydrating the porous glass preform obtained by the production method for the porous glass preform according to claim 2 in a heating furnace to vitrify the porous glass preform into transparent glass;
measuring a refractive index distribution in a radial direction for a plurality of places along a longitudinal direction of the transparent glass preform; and
calculating, by a computer, a feature quantity of the refractive index distribution from the refractive index distribution.

14. The production method for the transparent glass preform according to claim 13, wherein
when a relative refractive index difference Δ(r) at a position of a radius r in a core layer of an optical fiber is represented by Δ(r)=100×(n(r)−n)/n(r) with a refractive index n of a cladding layer of the optical fiber as a reference, a relative refractive index difference of a core center portion (r=0) is defined as Δ1, and a local maximum of a relative refractive index difference in a vicinity of an interface between the core layer and the cladding layer of the optical fiber is defined as Δ2,
the feature quantity of the refractive index distribution is at least one of Δ1, Δ2, a ratio of Δ1 and Δ2 calculated based on the refractive index distribution measured for the transparent glass preform, a core diameter, or an estimated value of an optical characteristic of an optical fiber of at least one of a cutoff wavelength, a mode field diameter, or a zero dispersion wavelength estimated from the refractive index distribution measured for the transparent glass preform.

15. The production method for the transparent glass preform according to claim 13, further comprising:
constructing a database of the feature quantity of the spatial relationship and the feature quantity of the refractive index distribution; and
constructing a trained model by using data accumulated in the database to include, as explanatory variables, the feature quantity of the shape of the deposition surface, the feature quantity of the shape of the burner flame, and the feature quantity of the spatial relationship and to include, as an objective variable, the feature quantity of the refractive index distribution, and by training a learning model using the explanatory variables and the objective variable.

16. The production method for the transparent glass preform according to claim 15, further comprising:
when a relative refractive index difference Δ(r) at a position of a radius r in a core layer of an optical fiber is represented by Δ(r)=100×(n(r)−n)/n(r) with a refractive index n of a cladding layer of the optical fiber as a reference, a relative refractive index difference of a core center portion (r=0) is defined as Δ1, and a local maximum of a relative refractive index difference in a vicinity of an interface between the core layer and the cladding layer of the optical fiber is defined as Δ2,
using the trained model to estimate, as the feature quantity of the refractive index distribution, a value of at least one of Δ1, Δ2, a ratio of Δ1 and Δ2, a core diameter, or at least one of a cutoff wavelength, a mode field diameter, or a zero dispersion wavelength, from the feature quantity of the shape of the deposition surface, the feature quantity of the shape of the burner flame, and the feature quantity of the spatial relationship calculated from the image data during production of the porous glass preform;
determining whether or not the value estimated deviates from a target value; and
when the value estimated deviates from the target value, deciding to perform at least one treatment of: stopping production of the porous glass preform, extending a production time of the porous glass preform, adjusting a condition of a gas used during production of the porous glass preform, adjusting a position of a burner which injects the burner flame, or performing maintenance on the burner.

17. A production method for a transparent glass preform which forms the transparent glass preform by depositing glass fine particles, which are generated by burner flame, on a tip of a starting material rotating about a vertical axis, and lifting the starting material to form a porous glass preform, and dehydrating the porous glass preform in a heating furnace to vitrify the porous glass preform into transparent glass, the production method comprising:
imaging, with one or more cameras, a deposition surface of the glass fine particles in the starting material and the burner flame, and acquiring image data obtained by projecting an image of the deposition surface and an image of the burner flame on a same coordinate plane; and
inputting the image data acquired newly to a trained model, which has learned a relationship between the image data during production of the porous glass preform and a value of an optical characteristic of an optical fiber, thereby causing the trained model to estimate the value of the optical characteristic.

18. The production method for the transparent glass preform according to claim 17, wherein
when a relative refractive index difference Δ(r) at a position of a radius r in a core layer of an optical fiber is represented by Δ(r)=100×(n(r)−n)/n(r) with a refractive index n of a cladding layer of the optical fiber as a reference, a relative refractive index difference of a core center portion (r=0) is defined as Δ1, and a local maximum of a relative refractive index difference in a vicinity of an interface between the core layer and the cladding layer of the optical fiber is defined as Δ2,
the value of the optical characteristic of the optical fiber is at least one of Δ1, Δ2, a ratio of Δ1 and Δ2, a core diameter, a cutoff wavelength, a mode field diameter, or a zero dispersion wavelength.

19. The production method for the transparent glass preform according to claim 17, further comprising, when the value estimated deviates from a target value, deciding to perform at least one treatment of: stopping production of the porous glass preform, extending a production time of the porous glass preform, adjusting a condition of a gas used during production of the porous glass preform, adjusting a position of a burner which injects the burner flame, or performing maintenance on the burner.

20. A production apparatus for a porous glass preform which forms the porous glass preform by depositing glass fine particles, which are generated by burner flame, on a tip of a starting material rotating about a vertical axis, and lifting the starting material, the production apparatus comprising:
one or more cameras which image a deposition surface of the glass fine particles in the starting material and the burner flame; and
a feature quantity calculation unit which acquires image data obtained by projecting, on a same coordinate plane, an image of the deposition surface and an image of the burner flame captured by the one or more cameras, and calculates a feature quantity of a spatial relationship between the deposition surface and the burner flame by performing image processing on the image data.
